(19) United States
(12) Patent Application Publication
(10) Pub. No.: US 2003/0225549 A1
(43) Pub. Date: Dec. 4, 2003

(54) Systems and methods for end-to-end quality of service measurements in a distributed network environment

(76) Inventors: A. David Shay, Lawrenceville, GA (US); Michael S. Percy, Marietta, GA (US); Jeffry G. Jones, Canton, GA (US); Robert O'Halloran, Atlanta, GA (US); Keri A. Richardson, Atlanta, GA (US)

Correspondence Address: Malvern U. Griffin III, SUTHERLAND ASBILL & BRENNAN LLP, 999 Peachtree Street, NE, Atlanta, GA, 30309-3996, US

(21) Appl. No.: 10/403,191

(22) Filed: Mar. 31, 2003

Related U.S. Application Data
(60) Provisional application No. 60/368,931, filed on Mar. 29, 2002.

(51) Int. Cl. G06F 11/30; G06F 15/00; G21C 17/00

(52) U.S. Cl. 702/182

(57) ABSTRACT

The present invention provides a framework for metering, monitoring, measuring, analyzing and reporting on network traffic data. The framework of the present invention is comprised of multiple synchronized components that each contribute highly specialized functionality to the framework as a whole. In certain configurations, the present invention includes two types of metering/measuring components, referred to as Instrumentation Access Points (IAPs). The first metering/measuring component is a terminal IAP, referred to as Node Workstation and Node Server. The second metering/measuring component is an edge IAP, referred to as Probe. Probe monitors all traffic that traverses the network segment upon which it is installed, while Node is limited to the traffic specific to the particular host (i.e., workstation or server). The IAPs communicate their data to monitoring, analysis, and reporting software modules that rely upon and reside in another component referred to as Diagnostic Server. The Diagnostic Server may accept data from the IAP and stores such data for use by software modules referred to as: Modeler, Trender and Reporter. These three software modules perform the monitoring, trending, capacity planning and reporting functions of the present invention.

### CROSS-REFERENCE TO RELATED APPLICATIONS

This application claims benefit of co-pending U.S. Provisional Application No. 60/368,931, filed Mar. 29, 2002, which is entirely incorporated herein by reference. In addition, this application is related to the following co-pending, commonly assigned U.S. applications, each of which is entirely incorporated herein by reference: “Methods for Identifying Network Traffic Flows” filed Mar. 31, 2003, and accorded Publication No. ______; and “Forward Looking Infrastructure Re-Provisioning” filed Mar. 31, 2003, and accorded Publication No. ______.

### TECHNICAL FIELD

The field of the present invention relates generally to systems and methods for metering and measuring the performance of a distributed network. More particularly, the present invention relates to systems and methods for providing end-to-end quality of service measurements in a distributed network environment.

### BACKGROUND OF THE INVENTION

The OSI model does not define any specific protocols, but rather the functions that are carried out in each layer. It is assumed that these functions are implemented as one or more formalized protocols as applicable to the particular data communication system being implemented. As a concrete example, the TCP/IP protocol model is conceptually simpler than the OSI model. It consists of just four layers (network access, internet, transport, application). The network access layer corresponds to the OSI physical and data link layers, and is defined in terms of physical networks such as Ethernet, Token Ring, ATM, etc. The Internet layer corresponds to the OSI network layer and includes protocols such as IP, ICMP, and IGMP. The transport layer is essentially the same in both models, and includes TCP and UDP. The application layer is broadly defined and includes functionality from the OSI session, presentation, and application layers. Protocols at this level include SMTP, FTP, and HTTP.

While traditional network monitors may classify and present information about application traffic, they are not really monitoring the applications themselves. They are instead providing stateless information about the protocols used by the applications and ignore higher-level information, such as session metrics. For example, they may report that workstation 10.0.0.1 was the source of 1000 FTP packets, but do not break down individual file transfers for throughput analysis. Such a breakdown requires state information, that is, knowing when an application initiates a transaction and when the transaction is completed.

The primary metric for application quality of service, at least for transaction-oriented applications, is application response-time or responsiveness. Therefore, any device configured to monitor application quality of service must be able to identify complete transactions or conversations. Some exceptions to this include streaming applications, such as Voice over IP (VoIP), for which the primary metric(s) change to throughput and jitter (packet inter-arrival variation), but the need to discern state information, such as per-call statistics, still exists.

Accordingly, a system is needed that combines data capture and analysis so as to provide real-time and continuous monitoring of end-to-end application quality of service, rather than snapshot, periodic and/or batch-oriented reporting.

### SUMMARY OF THE INVENTION

The present invention provides a framework for metering, monitoring, measuring, analyzing and reporting on network traffic data. The framework of the present invention is comprised of multiple synchronized components that each contribute highly specialized functionality (intelligence) to the framework as a whole. The component structure of the present invention provides flexibility that makes the framework scalable and robust. The framework of the present invention may be tailored to fit specific objectives, needs and operating processes. This tailored flexibility can dramatically lower the costs and effort expended on on-going technology management and customer support by allowing the framework to conform to an entity's support process rather than forcing entities to change their operating processes to match the tool.

The present invention also lowers the technical cost of managing infrastructures in terms of resource overhead and data warehousing by providing intelligent routing/filtering of collected information. By intelligently parsing captured data, information can be discretely grouped and delivered to vertically oriented resources and indeed specific individuals. This enables the benefit of just in time (JIT) information delivery, eliminating the need for batch/bulk uploads to massive back-end data repositories and the capital expenditure associated with abortive sorting and parsing systems.

In certain configurations, the present invention includes two types of metering/measuring components, referred to as Instrumentation Access Points (IAPs). The first metering/measuring component is a terminal IAP, referred to as NodeWS (Node Workstation) and NodeSVR (Node Server). NodeWS and NodeSVR are interchangeably referred to herein as Node(s). The second metering/measuring component is an edge IAP, referred to as Probe. Probe monitors all traffic that traverses the network segment upon which it is installed, while Node is limited to the traffic specific to the particular host (i.e., workstation or server).

The IAPs communicate their data to monitoring, analysis, and reporting software modules that rely upon and reside in another component referred to as Diagnostic Server. Diagnostic Server may be configured in two orientations, including a “Domain” version for supporting small to medium businesses or localized domain management and an “Enterprise” version for supporting large scale service providers and enterprise corporations. Each version of Diagnostic Server may accept data from the IAP and stores such data for use by software modules referred to as: Modeler, Trender and Reporter. These three software modules perform the monitoring, trending, capacity planning and reporting functions of the present invention.

Additional embodiments, examples, variations and modifications are also disclosed herein.

### BRIEF DESCRIPTION OF THE DRAWINGS

FIG. 1 is a high-level block diagram illustrating the components that make-up the framework of the present invention according to one or more exemplary embodiments thereof.

### DETAILED DESCRIPTION OF THE DRAWINGS

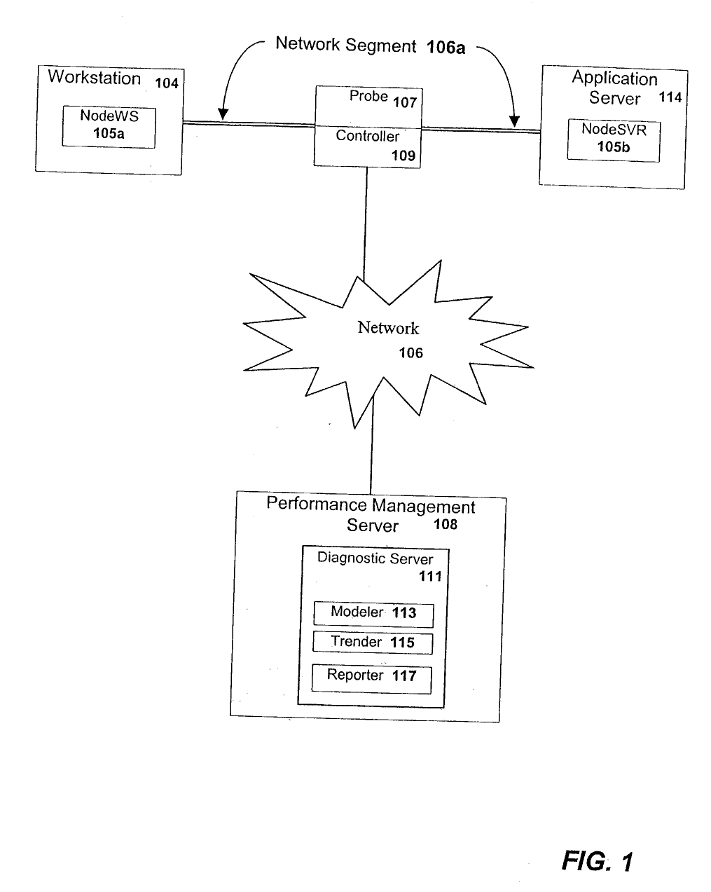

The present invention provides a flexible, scalable and robust system for providing end-to-end quality of service measurements in a distributed network environment. Exemplary embodiments of the present invention will now be described with reference to FIG. 1, which represents a high-level block diagram of a system in accordance with certain exemplary embodiments. As depicted, an exemplary operating environment includes various network devices configured for accessing and reading associated computer-readable media having stored thereon data and/or computer-executable instructions for implementing various methods of the present invention. The network devices are interconnected via a distributed network 106 comprising one or more network segments 106a. The network 106 may be composed of any telecommunication and/or data network, whether public or private, such as a local area network, a wide area network, an intranet, an internet and any combination thereof and may be wire-line and/or wireless.

Generally, a network device includes a communication device for transmitting and receiving data and/or computer-executable instructions over the network 106 and a memory for storing data and/or computer-executable instructions. A network device may also include a processor for processing data and executing computer-executable instructions, as well as other internal and peripheral components that are well known in the art (e.g., input and output devices.) As used herein, the term “computer-readable medium” describes any form of computer memory or a propagated signal transmission medium. Propagated signals representing data and computer-executable instructions are transferred between network devices.

A network device may generally comprise any device that is capable of communicating with the resources of the network 106. A network device may comprise, for example, a server (e.g., Performance Management Server 108 and application server 114), a workstation 104, and other devices. In the embodiment shown in FIG. 1, a Performance Management Server 108 hosts software modules for communicating with other network devices and for performing monitoring, trending, capacity planning and reporting functions. The Performance Management Server 108 is a specially configured component of the present invention. In contrast, the application server 114 is meant to generically represent any other network server that may be connected to the network 106. The term “server” generally refers to a computer system that serves as a repository of data and programs shared by users in a network 106. The term may refer to both the hardware and software or just the software that performs the server service.

A workstation 104 may comprise a desktop computer, a laptop computer and the like. A workstation 104 may also be wireless and may comprise, for example, a personal digital assistant (PDA), a digital and/or cellular telephone or pager, a handheld computer, or any other mobile device. These and other types of workstations 104 will be apparent to one of ordinary skill in the art.

Certain embodiments may include various metering/monitoring components, also referred to as instrument access points (“IAPs”), such as NodeWS (Node Workstation) 105a, NodeSVR (Node Server) 105b and Probe 107. NodeWS 105a and NodeSVR 105b are terminal IAP and may be referred to collectively as Node 105. Probe 107 is an edge IAP. In a sense, Probe 107 and Node 105 are application aware network monitors. Traditional network monitors, commonly called sniffers, use a passive network interface to identify and measure network traffic at the packet or cell level. Sniffers provide information about the lower four layers in the OSI network model (physical, data link, network, and transport), but largely or entirely ignore the upper three levels (session, presentation, application). Probe 107 and Node 105, on the other hand, are configured to provide information about all seven layers in the OSI network model.

The concept of measuring traffic flows, or conversations, is essentially the same for both Node 105 and Probe 107. A stream of network packets is presented to the metering/monitoring component. The component may be configured to classify the network packets into traffic flows, summarize attributes of the traffic flows and store the results for subsequent reporting and possible transfer to another component of the invention. The stream of network packets is pre-filtered to a particular host in the case of Node 105.

Node 105 is a software agent designed to attach to the protocol stack in workstations 104 and application servers 114. Node 105 performs traffic metering for the traffic that is sent to or from its host. In addition, Node 105 monitors the overall status of the host for KPIs (Key Performance Indicators) that might affect application responsiveness, such as CPU and memory utilization, streaming, current user login information, etc. While it is a straightforward task to obtain localized user login information at a workstation 104 where the mapping is generally one-to-one, multiple user logins must be correlated to multiple applications at the server end. Correlating multiple user logins to multiple applications provides views into resource allocation, performance and utilization characteristics at the process level. Apart from the obvious network interface, there are several other interfaces between Node 105 and other subsystems within the framework. In addition, there are user interfaces.

Probe 107 is a dedicated network traffic monitoring appliance that, through promiscuous network interface(s), continuously and in real-time classifies packets into traffic flows as described above. In terms of traffic classification, reporting, and diagnostic support, Probe 107 is virtually identical to Node 105 except that it sees all network traffic on the network segment 106a. Probe 107 may also include a direct user interface that provides “live” analysis of traffic data. Various views provide an analyst with information that may help diagnose problems immediately; whereas waiting for summarized data and reports may make it difficult to solve the problem in a timely fashion. In addition to the obvious network interface, there are several other interfaces between Probe 107 and other subsystems within the framework. In addition, there are user interfaces.

While Probe 107 is capable of providing packet analysis, it is designed to produce statistical information characterizing the application and network quality of service. Probe 107 also provides important information about application QoS through its graphical user interface. Since it is collecting transport and network information already, as required to measure application performance, Probe 107 may serve as a stand-alone device to provide functionality similar to traditional network monitors (i.e., packet-trace analysis).

Most good network analyzers can filter or present data by criteria, such as: source IP address, destination IP address, source Port, destination Port, and/or protocols (e.g., Ethernet, IP, ICMP, TCP, UDP, Telnet, FTP, HTTP). More sophisticated analyzers will make some attempts at decoding portions of the protocol attributes; others will simply present the data in text (ASCII) or numeric (hexadecimal) format. Probe 107 supports all of this and also interprets the data at the application level.

Probe 107 may be provided with a graphical user interface that allows an analyst or administrator to view live information about the traffic seen by Probe 107. Through this user interface, users can obtain chart and/or graphical representations of system metrics through different views. The traffic can be filtered, summarized, categorized and presented based on user selection criteria, much the same as traditional network analyzers present data. Application specific metrics must also be filtered, summarized, categorized and presented based on user criteria.

The user interface can be presented locally or remote with equal facility. Indeed, as a network appliance, Probe's 107 user interface may always be accessed remotely (much like routers and firewalls are often accessed). This eliminates the need for loading Probe 107 with a keyboard, mouse, and video display. In addition to a remote graphical user interface, Probe 107 may be configured for interacting with remote applications that depend on SNMP or RMON protocols to transport information to remote analysis tools, both within the framework of the present invention and with custom and/or third-party tools.

Node 105 and Probe 107 each summarize (or aggregate) the information that they collect and communicate the aggregate information to a Controller 109. According to certain embodiments of the invention, a Controller 109 is assumed to be within each “Domain.” A Domain is defined herein as a localized area of integrated Probes 107 and instrumented Nodes 105. Each Controller is responsible for managing all Probes 107 and Nodes 105 within its Domain. Each Controller 109 holds a database of Service Level criteria, and can use the aggregate data received from Node 105 and/or Probe 107 to valid the performance of each application, for each user, in terms of the required service levels that directly affect that user. Defined routing and filtering of Domain-oriented information can then be directed to specific repositories and indeed specific support personnel.

The aggregate data described above is sufficient to document or validate Service Level compliance. It is not, however, sufficient to pinpoint why required levels of service are not being met. While inferences can be made from the aggregate data, especially when similar aggregate data from several points between two nodes (workstation 104 and application server 114) are compared and correlated, there are conditions that require more information. In particular support personnel will need to be able to track a particular set of packets on their trip through the network 106, noting the time they passed each point in the network 106.

Node 105 and Probe 107 each support these diagnostic requirements by providing a mode (on demand, presumably in response to some alarm indicating service level breach) that allows selective accumulation of per-conversation data (rather than aggregating many conversations during an interval). The per-conversation data, with its time tags and identifying data, is reported to Controller 109, and eventually to Diagnostic Server 111, where data from different instrumentation points can be correlated into a comprehensive picture of the entire application performance including network, workstation 104, and application server 114 information. The collection of per-conversation information can require more memory consumption in the workstation 104, as well as more network bandwidth. This is the price that must be paid when this diagnostic mode is required. However, the diagnostic mode may be invoked when the requirement is demanded and turned-off when not appropriate.

Controller 109 is the primary repository for Service Level definitions and provides a data service to Node 105 and Probe 107. Node 105 and Probe 107 receive Service Level-related information from Controller 109, including service level requirements and thresholds, applications to be monitored, measurement intervals and where and to whom data should be sent. This information is used to limit the applications or protocols that Node 105 and Probe 107 need to report. Node 105 and Probe 107 provide a data stream service to Controller 109. That data stream consists of periodic (user-defined frequency) transfers of aggregate interval data.

Controller may also emit commands to Node 105 and/or Probe 107 asynchronously. These commands might reflect updated Service Level (filter) data, or might request that Node 105 and/or Probe 107 begin providing diagnostic-level data (i.e., per-conversation data) rather than normal aggregate data.

Node 105 and Probe 107 use a discovery protocol to locate the Controller 109 that “owns” that node. This avoids requiring any configuration information to be retained within the Node 105 or Probe 107. Node 105 also informs Controller 109 about its host address (IP & MAC), as well as the login information of the user. This permits Controller 109 to map traffic data to a user and users to SLAs. Accordingly, service level and QoS metrics can be applied to transactions generated by the exact users to which quality expectations and guarantees apply. This process occurs within Controller 109 instead of the back-end processing currently offered by other solutions to facilitate immediate notification of non-compliance situations.

Controller 109 receives collected data from Probes 107 and Nodes 105 at specified time intervals. Once the data arrives at Controller 109, it is analyzed and transported to Diagnostic Server 111 where it is then utilized by Modeler 113, Predictor 115, and Reporter 117. The diagnostic capabilities of Controller 109 complement those of Node 105 and Probe 107. When Controller 109 indicates a certain service level or quality of service threshold is being breached, it invokes on-demand per-conversation reporting by the applicable Probes 107 and Nodes 105. Controller 109 receives this per-conversation information, analyzes it and sends it to Diagnostic Server 111 for further processing and reporting. When it is determined that the non-compliance situation has ended, Controller 109 sends an instruction to Probe 107 and Node 105 that causes them to revert to normal “all-clear” reporting mode, in which summary traffic data is collected. Controller 109 may be provided with a graphical user interface so that applicable service levels, application identification information and measurement criteria can be entered and subsequently transmitted to Probe 107 and Node 105.

Packet capture is the act of observing all network traffic. Node 105 observes all traffic into and out of the host (e.g., workstation 104 or application server 114) it is running on, while Probe 107 observes all traffic on the network segment 106a. Packet capture may be accomplished with select network interface cards (“NIC”) by commanding them to enter promiscuous mode. Normally, a NIC on a shared-media network, such as Ethernet, uses hardware-based filtering to ignore all packets not addressed, at the link layer (MAC address), to that particular NIC. Promiscuous mode disables the MAC address filtering and allows the NIC to see all packets regardless of the designated recipient.

Observation of all network traffic may result in what appears to be a significant amount of data. But, consider that a fully loaded, collision-free 100baseT Ethernet network carries only 12.5 megabytes of data per second. In packet terms, this is slightly more than 195,312 minimum-sized packets per second, or about one packet every 5.12 microseconds. Actual capacity will likely be somewhat less due to signaling overheads (the preamble, which allows start-of-packet synchronization, is the equivalent of 8 bytes per packet) and collisions that reduce effective capacity even more. In fact, when assuming minimum packet size, signaling overhead and packet checksums represent nearly 17% of the bandwidth. Also note that the preamble and CRC are not usually available to upper layers of the protocol stack, so the actual amount of effective bandwidth is that much smaller. Adding some perspective, a 700 MHz processor that executes one instruction per clock would be able to execute more than 3500 instructions per packet in this worst-case scenario. In any case, whether in Node 105 or Probe 107, a packet capture mechanism may be postulated that produces a stream of packets. The packet stream can be fed into the next step of the traffic flow metering process, which is traffic classification.

Once the packets are captured by Node 105 and Probe 107, they must be classified, or put into specific categories so that they can be properly processed. The first step in classifying packets is to parse them. Parsing is the act of identifying individual fields in the packet. Most protocol headers have a fixed header, which tells us how to interpret the variable portion of the packet (the payload). After the packets are parsed, the information in each field can be used to classify the type of packet in terms of sender, receiver, protocol, application, etc. Once classified, a set of operations appropriate to the packet's categories can be invoked. For example, we can identify all packets involved in a particular session, then compute session statistics.

Each layer in the protocol stack (TCP/IP over Ethernet will be assumed herein by way of example only) encapsulates data from the next-highest layer, usually adding header and/or trailer information. For example, consider the example where an FTP client asks TCP to transmit some data to an FTP server, having previously established a TCP session with the FTP server application. TCP will take the data from the application, break it up into properly sized chunks, and add a TCP header to each segment (the TCP header is generally 20 bytes that include source and destination ports, sequence and acknowledgment numbers, etc.). TCP will then ask IP to send the segments to the FTP server machine. IP will break the segments into properly sized chunks and construct one or more IP datagrams, each with an IP header (the Ipv4 header is generally 20 bytes that include source and destination IP address, header and data lengths, protocol an type-of-service identifiers, and fragmentation data). IP will then ask the network layer (e.g., Ethernet) to transmit them. Ethernet constructs an Ethernet frame, each with an Ethernet header (6-byte source and destination MAC addresses, and two more bytes with additional information), which is then transmitted onto the carrier media. Note that the transceiver hardware generates the preamble bits and a 4-byte trailing CRC.

Parsing an Ethernet packet involves, at a minimum, breaking out the headers of each encapsulating protocol layer. The information in each layer's header indicates how to break up the header fields (some layers have variable-length headers), and usually indicate something about the next protocol layer. For example, the IP header will indicate whether the datagram is transporting TCP, UDP, RTP, or RSVP. This allows the transport layer protocol to be identified as, e.g., TCP for appropriate parsing.

Finally, although TCP/IP does not specifically identify the concept, most applications will embed a session protocol in their datastreams. For example, the FTP application layer defines a score of commands (e.g., USER, PASS, and CWD) that the application may use. These commands are not included in a header, per se, instead appearing as bytes in the FTP data stream. As application-aware monitors, Probe 107 and Node 105 are therefore configured to scan the data portion of the packets and use pattern matching and other techniques to discern session-level and application-level data elements that might be critical to the metrics being collected.

After parsing a packet, Node 105 and Probe 107 may classify the packet easily by the various protocols used. However, classification alone is not sufficient to assign the correct meaning to the data. In order to be able to assign the correct meaning to the data, the application that generated the traffic must be known. In other words, the application provides the critical context in which to interpret the data. By examining the TCP/IP port numbers, the application that generated the traffic may usually be identified.

Before two application processes can communicate across a TCP/IP network, they must each indicate to the TCP process on their own host that they are ready to send and/or receive information. An application process that wants to initiate or accept connections must provide the TCP process with a port/socket number that is unique, at that time, on that host. To open a connection to an application process on a remote host, the local application process must know the remote application process's open port number. Fortunately, most applications use a well-known port number, which is a generally agreed upon number (ports 0-1023 are managed by the Internet Assigned Numbers Authority, ports 1024-65535 are not officially managed but many ports are unofficially reserved for specific applications). Communication links are therefore described in terms of a source address and port paired with a destination address and port.

To avoid tying up a well-known port with a single connection, one of the first things certain applications do after establishing a TCP connection to a well-known port is to establish a secondary port. This secondary port is a port not currently in use by any other connections or well-known services. Once the secondary port has been established, the connection is migrated to the secondary port. The original connection is then terminated, freeing the well-known port to accept additional connections.

Therefore, for applications with well-known ports, it can be assumed that traffic to those ports is specific to the application associated with the port. Further, by observing the migration of well-known port connections to secondary ports, it may be determined that the traffic on the secondary ports also is specific to the application associated with the original well-known port. Still, the termination of secondary port connections must be observed to see if the host recycles the secondary port number and possibly assigns it to some other application.

In some cases, a port is associated with more than one application. For example, a TELNET application may actually be a front-end for a number of hosted text-base applications. For example, a Citrix Metaframe sever may be hosting Peoplesoft and Microsoft Word. Without some ability to further parse and interpret the data, the actual application used may be obscured and incorrectly categorized. This additional interpretation of application identification is characterized by process identifiers, user identifiers, etc.

As mentioned, Node 105 and Probe 107 can measure network traffic from both a flow and a conversation perspective. Flow related measurements associate recorded packet movement and utilization with time, while conversation measurements group flow related activities into “pairs” of bi-directional participation. Although some traffic is connectionless, each connection-oriented packet transmitted must be associated as part of some traffic flow (sometimes called connections, conversations, transactions, or sessions). Indeed, for many transaction oriented applications, the time between the initial connection to the well-known port and the termination of the (secondary) connection represents the transaction duration and is the source of the primary metric referred to as application response time.

To meter traffic flows (modeled as a conversation unit) Node 105 and Probe 107 must examine each packet to determine if it is the first packet in a new flow, a continuation packet in some existing flow, or a terminating packet. This determination may be made by examining the key identifying attributes of each packet (e.g. source and destination addresses and ports in TCP/IP) and matching them against a table of current flows. If a packet is not part of some existing flow, then a new flow entry may be added to the table. Once a packet is matched with a flow in the table, the packet's attributes may be included in the flow's aggregate attributes. For example, aggregate attributes may be used to keep track of how many bytes were in the flow, how many packets were in the flow, etc. If the packet is a terminating packet, the flow entry in the table is closed and the aggregate data is finalized. The flow's aggregate data might then be included in roll-up sets. For example, in the case of Probe 107 and Node 105, the network administrator may be interested in per-flow and aggregate data per user per application.

To allow association of traffic to a particular user, there must be some facility in place that captures user identification information so that it can be mapped to addresses used. For example, when “Betty Lou” logs into her workstation 104, the workstation 104 will have an IP address assigned to it (which may change at some rate specified by the DHCP server, if one is used). User information and IP address may be captured so that traffic seen at other points in the network 106 can be mapped to “Betty Lou.” In addition, traffic must be associated to a particular service level agreement (“SLA”). This is achieved by mapping user ID's (or groups) to service level definitions.

To complicate correlation of end-to-end modeling of bi-directional conversation flows, network address translation (NAT) introduces the inability to resolve origination-to-destination target addressing. NAT hides or translates origination/destination node identifiers, such as IP addresses, along the conversation path. Before an end-to-end flow map can be constructed detailing point-to-point performance indicators, these addresses must be resolved and correlated. Several techniques may be used for overcoming the problems associated with NAT. For example, artificial test packets may be injected into the network segment 106a that can clearly be identified at each endpoint (for example, by forcing the packet to contain a particular pattern that is unlikely to occur normally in the network 106). Another technique for overcoming problems associated with NAT is referred to as “conversation fingerprinting.” Generally, conversation fingerprinting involves applying a patent-pending signature mapping formula to each conversation flow. Unlike all other methods and approaches requiring packet tagging or other invasive packet modifiers, conversation fingerprinting is non-intrusive and does not modify packets. Conversation fingerprinting enables the ability to “follow the worm” regardless of address translation; thus allowing performance measurements to be made and reported on an end to end basis. Methods for performing conversation fingerprinting are more fully described in the U.S. Provisional Patent Application entitled “Methods For Identifying Network Traffic Flows,” filed on Mar. 31, 2003, assigned Publication Number ______.

Measurements regarding network traffic may be converted into metrics for some useful purpose, for example to validate the actual delivery of application quality of service (“QoS”). In accordance with certain embodiments of the present invention, a key performance indicator of QoS is the service level that is actually being delivered to the end-user. An application service level agreement (“SLA”) is an agreement between a provider and a customer that defines acceptable performance levels and identifies particular metrics that measure those levels. The particular metrics and/or thresholds may be different for different combinations of applications and end-users.

In addition, there are likely financial consequences for failure to meet the service guarantee specified in an SLA. Customers and providers both have a stake in verifying delivery of application services. Customers want to be sure they are getting what they paid for. When the Service Provider's quality-of-service failures impact the bottom line of the customers, customers will demand compensation (e.g., penalties). Providers that face penalties for noncompliance want to ensure they can prove the guaranteed quality of service is in fact being delivered. Customers and providers also face the additional problem of estimating the impact of new users and/or applications on their network(s). All of these issues involve identifying the metric (measurement to be made) and establishing thresholds for the metrics that define good and poor service levels.

Probe 107 and Node 105 measure and provide visibility into multiple customer-defined metrics. In particular, Probe 107 and Node 105 are aware of extant service level agreements, their QoS definitions and thresholds that might impact the observed traffic. Probe 107 and Node 105 may be provided with functionality to direct the actions required when the metrics indicate a violation of the service guarantee.

Traditional network analyzers provide several metrics related to network performance. While not necessarily complete, the following list represents network metrics: availability; network capacity; network throughput; link-level efficiency; transport-level efficiency; peak and average traffic rates; burstiness and source activity likelihood; burst duration; packet loss; latency (delay) and latency variation (jitter); bit error rates. These metrics are necessary, but not sufficient, to define metrics for application quality of service.

For most applications, the critical metric is application response time, as perceived by the end user. Related metrics such as application throughput and node “think-times” are also critical metrics for defining application quality of service that are largely ignored by network-centric systems. In transactional system, application response time may be defined as the time it takes for a user's request to be constructed, to travel across the network 106 to the application server 114, to be processed by the application server, and for the response to travel back across the network 106 to the user's workstation. There are some variations on this definition, such as whether the time interval measurement should begin with the first or last packet of the user's request, whether the time interval measurement should end with the first or last packet of the server's response, etc. However, with the above basic definition in mind, a candidate metric can be defined.

While application response time is probably the critical metric for determining end-user application quality of service, by itself it indicates very little about the quality of service. A more general metric, application responsiveness, must include information about the size of the request and the size of the response. If a transaction involves 100 Mb of data, then a 1.5-minute response time is actually very good. The application responsiveness metric must also include areas of performance associated with node orientations.

Application response time is meant to indicate the total delay between request and response. But this includes a number of independent factors, such as network delay, server delay and workstation delay. Network delay is the amount of time it takes to send the request and the response. This includes wire time (actually moving bits), network mediation and access times (collision detection and avoidance), network congestion back-off algorithms, routing overheads, protocol conversion (bridges), retransmission of dropped or broken packets. In general, everything involved in actually moving data. Note that by itself, this metric is generally not sufficient to validate an SLA. For example, it may be impossible for an ASP to know that the problem causing SLA breaches is not due to increased traffic on the customer's LAN.

Server delay is the amount of time between when the server receives the request and the time it produces a response. An overloaded server may cause extended transaction delays as new requests are queued while previous requests are being processed. Also, certain transactions may require significant processing time even in the absence of other transactions loaded (e.g., a complex database query). Workstation delay may occur, for example, when a user initiates a transaction and then some other resource intensive process begins, such as an automated virus scan or disk defragmentation. Thus, the workstation itself may contribute to overall delay by taking longer than normal to produce acknowledgment packets, etc.

By synchronizing and using a combination of the above-described metrics, performance problems and their locations may be identified and responsibility may be allocated. As an example, consider a typical case, where there is a workstation 104 on a customer LAN using the Internet to access an application server 114 on a provider's LAN. In this case, the provider is likely to avoid penalties if he can prove that responsiveness at his end is adequate. That is, once the request arrives at the edge of the provider's LAN, it is delivered and processed and the result is delivered back to the edge of the providers LAN within the performance thresholds. If the customer is experiencing an apparent Service Level breach, it could be as a result of the Internet, the customer's LAN or the user's workstation. Synchronized Probes 107 may be strategically placed at different points on the network 106, such as at the edges of the customer's LAN and the provider's LAN, and information from the Probes 107 may be correlated to isolate the offending network segment 106a or device.

As mentioned, Controller 109 may be configured to periodically transmit network traffic data to Diagnostic Server 111. Diagnostic Server 111 represents the data management software blade that can be located in a centralized Performance Management Server 108 or in multiple Performance Management Servers 108. The Performance Management Server(s) 108 can either be located at the customer site(s) under co-location arrangements or within a centralized remote monitoring center. The flexibility of the framework allows the management platform(s) to be located wherever the customer's needs are best suited. One physical instance of Diagnostic Server 111 can handle multiple customers. By way of example only, an Oracle 8i RDBMS for enterprise size infrastructures or MySQL for small/medium business (SMB) implementations may support the management platform; each providing a stable and robust foundation for the functionality of Modeler 113, Trender 115 and Reporter 117. Modeler 113, Trender 115 and Reporter 117 all reside within the management platform of Diagnostic Server 111.

Diagnostic Server 111 receives data stream services from Controller at user-defined intervals. Diagnostic Server 111 stores that data for use by Modeler 113, Trender 115, and Reporter 117. Modeler 113 produces data models (based on user-defined criteria) that automatically update to reflect changes in the currently modeled attribute as Diagnostic Server 111 receives each interval of data. This interface is ideal for the monitoring of extremely critical Quality of Service metrics and for personnel with targeted areas of concern requiring a near real-time presentation of data. The user interface for Modeler 113 may include data acquisition and presentation functionality. Data must be gathered from the user as to what models are to be constructed and with what characteristics. Data will then be presented to the user in a format that can be manipulated and viewed from a variety of perspectives. Once a model has been created and is active, Modeler 113 will request specific pieces of data from the Diagnostic Server 111 to update that model as the data arrives at predetermined intervals.

Trender 115 utilizes traffic flows from Diagnostic Server 111 in order to provide a representation of the current network environment's characteristics. Once a ‘baseline’ of the current environment has been constructed, Trender 115 introduces variables into that environment to predict the outcome of proposed situations and events. In particular, Trender 115 imports traffic flows from Diagnostic Server 111 in order to construct a ‘canvas’ of the operating environment. The amount of data imported into Trender 115 varies given the amount of data that represents a statistically sound sample for the analysis being performed. Once the data is imported, Trender 115 can then introduce a number of events into the current operating environment in order to simulate the outcome of proposed scenarios. The simulation capabilities of Trender 115 may be used to project the network architecture's behavioral trends into the future and provide predictive management capabilities. Thus, the outputs generated by Trender 115 may be used for capacity planning, trending, and ‘what-if’ analyses.

Reporter 117 is a reporting engine (e.g., SQL-based) that communicates with Diagnostic Server 111 to request views of data based on any number of criteria input by its user. These requests can be made ad-hoc or as scheduled events to be initiated at customer defined intervals of time. The reports generated by Reporter 117 can be run (on demand or automatically scheduled) over any given interval or intervals of time for comprehensive views of aggregated quality of service performance. Support and management personnel can define views that follow their individual method of investigation and trouble-shooting. This flexibility lowers time to resolution by conforming the tool to their process rather than requiring them to change their process of analysis.

In certain embodiments, the user interface for Reporter 117 may be configured as a Web-enabled portal, allowing for information capture from the user as well as display of the requested report. Although the report may be produced using another medium (i.e. HTTP, Microsoft Word, email, etc.) the user is able to view some representation of the report before the final product is produced. Individual users can select and construct personalized views and retain those views for on-going use. Reporter 117 may provide secured limited or defined view availability based upon user access as required by each customer. Personalization of user “portlets” enables the present invention to create virtual network operations centers (virtual NOCs) for each support and management personnel; thus supporting discrete JIT information directed toward the support effort.

The interface from Reporter 117 to Diagnostic Server 111 may be based on Oracle's Portal Server framework and may leverage SQL commands executed upon the database. Diagnostic Server 111 may return a view of the data based on the parameters of the SQL commands.

Some of the measurements that are converted to metrics as described above are also functions of other measured performance characteristics. For example, the bandwidth, latency, and utilization of the network segments as well as computer processing time govern the response time of an application. The response time metric may be described as a service level metric whereas latency, utilization and processing delays may be classified as component metrics of the service level metric. Service level metrics have certain entity relationships with their component metrics that may be exploited to provide a predictive capability for service levels and performance.

The present invention may include software modules for predicting expected service levels. Such modules may processes the many metrics collected by Node 105 and Probe 107 representing current conditions present in the Network 106 in order to predict future values of those metrics. Preferred methods for determining predicted values for performance metrics are discussed in more detail in U.S. patent application Ser. No. entitled “Forward-Looking Infrastructure Reprovisioning,” filed on Mar. 31, 2003, assigned Publication Number ______. Those skilled in the art will appreciate that any other suitable prediction methods may be used in conjunction with the present invention as well. Based on predicted service level information, actions may be taken to avoid violation of a service level agreement including, but not limited to deployment of network engineers, reprovisioning equipment, identifying rogue elements, etc.

From a reading of the description above pertaining to various exemplary embodiments, many other modifications, features, embodiments and operating environments of the present invention will become evident to those of skill in the art. The features and aspects of the present invention have been described or depicted by way of example only and are therefore not intended to be interpreted as required or essential elements of the invention. It should be understood, therefore, that the foregoing relates only to certain exemplary embodiments of the invention, and that numerous changes and additions may be made thereto without departing from the spirit and scope of the invention as defined by any appended claims.

What is claimed is:

1. A system for providing real-time, continuous end-to-end quality of service measurements and usage based metrics, in situ, in a distributed network environment comprising:
a node that meters network packets flowing through a workstation connected to a distributed network, the node configured to classify the network packets flowing through the workstation into workstation traffic flows and to generate aggregate node data comprising summarized attributes of the workstation traffic flows;
a probe that meters network packets flowing through a network segment of the distributed network, the probe configured to classify the network packets flowing through the network segment into network segment traffic flows and to generate aggregate probe data comprising summarized attributes of the network segment traffic flows at one or more layers of the protocol stack;
a controller connected to the distributed network and in communication with a database of service level criteria, the controller configured to receive the aggregate node data from the node and the aggregate probe data from the probe and to analyze the aggregate node data and the aggregate probe data to determine whether any of the service level criteria are breached; and
a diagnostic server connected to the distributed network and that receives data from the controller and performs monitoring functions based on the data.

2. The system of claim 1, wherein the controller is further configured to command the probe to collect and transmit per-conversation probe data instead of aggregate probe data, in response to detecting a breach of any of the service level criteria based on the aggregate probe data.

3. The system of claim 1, wherein the controller is further configured to command the node to collect and transmit per-conversation node data instead of aggregate node data, in response to detecting a breach of any of the service level criteria based on the aggregate node data.

4. The system of claim 1, wherein the attributes of the workstation traffic flows and the attributes of the network segment traffic flows provide information about all seven layers in the OSI network model.

5. The system of claim 1, wherein diagnostic server further performs trending, capacity planning and reporting functions based on the data.

6. A method for providing real-time, continuous end-to-end quality of service measurements and usage based metrics, in situ, in a distributed network environment comprising:
metering at a node network packets flowing through a workstation connected to a distributed network, and the node further classifying the network packets flowing through the workstation into workstation traffic flows and generating aggregate node data comprising summarized attributes of the workstation traffic flows;
metering at a probe network packets flowing through a network segment of the distributed network, the probe further classifying the network packets flowing through the network segment into network segment traffic flows and generating aggregate probe data comprising summarized attributes of the network segment traffic flows at one or more layers of the protocol stack;
receiving at a controller the aggregate node data from the node and the aggregate probe data from the probe and the controller analyzing the aggregate node data and the aggregate probe data to determine whether any of the service level criteria are breached, the controller being connected to the distributed network and in communication with a database of service level criteria; and
receiving at a diagnostic server connected to the distributed network data from the controller, the diagnostic server performing monitoring functions based on the data.

7. The method of claim 6, further including the controller commanding the probe to collect and transmit per-conversation probe data instead of aggregate probe data, in response to detecting a breach of any of the service level criteria based on the aggregate probe data.

8. The method of claim 6, further including the controller commanding the node to collect and transmit per-conversation node data instead of aggregate node data, in response to detecting a breach of any of the service level criteria based on the aggregate node data.

9. The method of claim 6, wherein the attributes of the workstation traffic flows and the attributes of the network segment traffic flows provide information about all seven layers in the OSI network model.

10. The method of claim 6, further performing trending, capacity planning and reporting functions based on the data by the diagnostic server.
